(19) United States
(12) Patent Application Publication
(10) Pub. No.: US 2014/0000045 A1
(43) Pub. Date: Jan. 2, 2014

(54) FILTER ELEMENT CLEANING DEVICE

(71) Applicants: Michael David Bunting, Gilbert, AZ (US); Denise Marie Bunting, Gilbert, AZ (US)

(72) Inventors: Michael David Bunting, Gilbert, AZ (US); Denise Marie Bunting, Gilbert, AZ (US)

(21) Appl. No.: 14/019,758

(22) Filed: Sep. 6, 2013

Related U.S. Application Data
(63) Continuation-in-part of application No. 13/422,269, filed on Apr. 13, 2012, now abandoned.
Application No. 13/422,269 is a continuation-in-part of application No. 13/396,301, filed on Jul. 20, 2012.

(51) Int. Cl. B01D 35/16

(52) U.S. Cl. CPC B01D 35/16
USPC 15/104.05; 134/166 C

(57) ABSTRACT

A filter element cleaning device is provided. The device has body portion having a central bore and opposing distal ends. An end cap can be releasably coupled to the first end and a connector can functionally engage the second end. A plurality of apertures can be configured on the body portion between the opposing distal ends, the plurality of apertures being spaced apart a first distance from one another, the apertures being in fluidic communication with the central bore. An end aperture of the plurality of apertures can be spaced away from the first opposing distal end a second distance that is greater than the first distance. The device can include an aperture cleaning tool that is configured to be coupled to the end cap, such that the aperture cleaning tool is housed within the central bore of the body portion and can be removed to clean the apertures.

### CROSS REFERENCE TO RELATED APPLICATIONS

This application is a continuation-in-part of the earlier U.S. Patent Application to Bunting et al., entitled “POWER PIC PRO,” Ser. No. 13/422,269, filed Apr. 13, 2012, and is a continuation-in-part of the earlier U.S. Patent Application to Bunting et al., entitled “POWER PIC,” Ser. No. 13/396,301, filed Jul. 20, 2012, the disclosures of which are hereby incorporated entirely herein by reference.

### BACKGROUND

1. Technical Field

This disclosure relates generally to cleaning cartridge filters, and in particular to an improved apparatus for cleaning said filters.

2. State of the Art

Cartridge filters are utilized to filter dirt, debris and other unwanted particles out of fluids of all types. For example, cartridge filters are found in pools and spas and are also found in air-intakes of a variety of mechanical devices. Once these cartridges get dirty, performance diminishes and it becomes necessary to clean the cartridges so they continue to perform as intended.

Several devices have been developed to address the cleaning of cartridge filters. For example, U.S. Pat. No. 6,463,943 to Monroe and U.S. Pat. No. 6,715,501 to Pociask show circular ring type nozzles with a fixed inner diameter that is intended to fit over a cylindrical cartridge filter to meet the objective of cleaning the filter in a 360° degree application.

Although these device(s) meet the basic objective of cleaning cartridge filters, they are limited in scope and effectiveness. The designs limit the devices use to smaller diameter filters and exclude filters with diameters larger than the devices ring type nozzle and/or housing itself. Further, these designs result in significant back-splash onto the operator while cleaning, due to the devices spraying water in a 360° degree application.

Further, U.S. Pat. No. 4,417,596 to Pahlen utilizes an annulus housing that encloses and contains the cartridge filter during the cleaning process. This again limits the diameter, size and the overall length of the cartridge filters that can be cleaned by the device.

In U.S. Pat. No. 8,276,605 to Heathcoat et al., the nozzle design directs water flow through the device to an open cavity or bell nozzle, thus lowering needed back pressure and in turn lowering the impact pressure from the device to the cartridge filter. Further, the design includes pleat separating projections that can damage the filter media and retaining rings.

In U.S. Patent Publication. No. 2012/0260954 to Southwell et al. and PCT/US2008/082727 to Haynam et al., the design of these device(s) show in FIG. 4 for both prior art(s) of how it cleans from the inside-out only and utilizes the water jets to rotate the filter for 360° cleaning This eliminates the design(s) ability to clean air filters from the outside in which is a large portion of the industry.

Therefore, the foregoing examples do not teach: (1) effective water volume manipulation; (2) even distribution of water volume without a significant loss of impact pressure; (3) effective water penetration to the back of the cartridge filter pleats where most of the debris is collected; (4) maintained integrity of the filter media and micron ratings; (5) universal use on all size cartridge filters without limitation; (6) the ability to clean both inside-out and outside-in; or (7) do not show enough water conservation to be considered a green sustainable product.

There is thus a need in the industry for a filter element cleaning device, such as a device for cleaning cartridge filters, that addresses the concerns listed above.

### SUMMARY

The present disclosure relates to cleaning cartridge filters, and in particular to an improved apparatus for cleaning said cartridge elements.

An aspect of the present disclosure includes a device for cleaning a filter element, the device comprising a body portion having a central bore there through and opposing distal ends, an end cap configured to be releasably coupled to a first opposing distal end, a connector configured to functionally engage a second opposing distal end, a plurality of apertures configured on the body portion between the opposing distal ends, the plurality of apertures being spaced apart a first distance from one another, the apertures being in fluidic communication with the central bore, and an end aperture of the plurality of apertures, wherein the end aperture is spaced away from the first opposing distal end a second distance greater than the first distance.

Another aspect of the present disclosure includes wherein the central bore of the body portion is configured to receive a pressurized fluid from a pressurized fluid source and direct the pressurized fluid out of the plurality of apertures.

Another aspect of the present disclosure includes wherein the second distance creates a fluidic back pressure in the body portion resulting in an even dispersion of the pressurized fluid from each of the plurality of apertures.

Another aspect of the present disclosure includes wherein the plurality of apertures direct the pressurized fluid source out of the body portion in a direction substantially orthogonal to an axis of the body portion.

Another aspect of the present disclosure includes wherein the end cap fluidically seals the first opposing distal end.

Another aspect of the present disclosure includes wherein the plurality of apertures are aligned in parallel with an axis of the body portion.

Another aspect of the present disclosure includes wherein the plurality of apertures are drilled into the body portion.

Another aspect of the present disclosure includes wherein the body portion is cylindrical.

Another aspect of the present disclosure includes wherein the connector is configured to receive and retain thereon a pressurized fluid source.

Another aspect of the present disclosure includes wherein the pressurized fluid source is a residential water line.

Another aspect of the present disclosure includes further comprising a handle, wherein the handle is configured to be inserted between the connector and a pressurized fluid source.

Another aspect of the present disclosure includes wherein the handle has a central bore and opposing ends, the handle being configured to releasably couple to the connector on a first opposing end and to releasably couple to a pressurized fluid source on a second opposing end.

Another aspect of the present disclosure includes wherein the handle is configured to restrict a flow of the pressurized fluid source to increase or decrease the pressure of the fluid within the central bore of the body portion. Restriction of the flow of the pressurized fluid may be accomplished by implementing a ball valve at some point along the path of the pressurized fluid.

Another aspect of the present disclosure includes a first aperture of the plurality of apertures, the first aperture being positioned a third distance from the second opposing distal end, the third distance being greater than the second distance.

Another aspect of the present disclosure includes the central bore having a diameter, the diameter being substantially the same as the second distance.

Another aspect of the present disclosure includes wherein the body portion can be manufactured to varying lengths.

Another aspect of the present disclosure includes A device for cleaning a filter element, the device comprising a body portion having a central bore there through and opposing distal ends, an end cap configured to be releasably coupled to a first opposing distal end, a connector configured to functionally engage a second opposing distal end, a plurality of apertures configured on the body portion between the opposing distal ends, the plurality of apertures being spaced apart a first distance from one another, the apertures being in fluidic communication with the central bore, an end aperture of the plurality of apertures, wherein the end aperture is spaced away from the first opposing distal end a second distance greater than the first distance, and an aperture cleaning tool, the aperture cleaning tool being configured to releasably couple to the end cap, such that the aperture cleaning tool is housed within the central bore of the body portion.

Another aspect of the present disclosure includes wherein the aperture cleaning tool is cylindrical and has a diameter substantially the same as the diameter of each of the plurality of apertures, such that under the condition the aperture cleaning tool is detached from the end cap the aperture cleaning tool may be inserted within each of the apertures and slidably engage the apertures.

Another aspect of the present disclosure includes wherein the aperture cleaning tool has a surface feature.

Another aspect of the present disclosure includes wherein the surface feature is a ribbed section, wherein the ribs run parallel with an axis of the cleaning tool.

The embodiments of the device disclosed herein comprise the functions of cleaning of washable, reusable filtration devices and media for: high performance air filters, ambient air filters, dust collectors, vacuum systems, water purification & desalination systems, HVAC & HEPA systems, clean room systems, air cooled fin type systems such as radiator or push systems, pools, spas and more . The disclosed device works across many industries that utilize some sort of filtration device or media whereas periodic maintenance is required to ensure proper & peak performance as recommended by the OEM (Original Equipment Manufacturer). The present disclosure also works in various industries whereas no filtration device or filtration media is present but periodic maintenance is needed to maintain peak and proper performance.

While originally designed to clean washable, reusable high performance air in-take filters in the automotive industry, the embodiments of the disclosed device have grown and are currently being used in: the wood working industry for dust collectors, portable water desalination units, ambient air filtration and in the pool & spa industries to name a few. It is this reason that the basic nozzle design remains the same but the length can vary depending on the particular industries requirements and application.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1A is a side view of an embodiment of a filter element cleaner in accordance with the present disclosure.

FIG. 1B is an alternative side view of an embodiment of the filter element cleaner in accordance with the present disclosure.

FIG. 2A is an exploded side view of an embodiment of the filter element cleaner in accordance with the present disclosure.

FIG. 2B is an exploded alternative side view of an embodiment of the filter element cleaner in accordance with the present disclosure.

FIG. 3 is a side view of a component of an embodiment of the filter element cleaner in accordance with the present disclosure.

FIG. 4 is a cross-sectional side view of a component of an embodiment of the filter element cleaner in accordance with the present disclosure.

FIG. 5 is an alternative side view of a component of an embodiment of the filter element cleaner in accordance with the present disclosure.

FIG. 6 is a side view of a component of an embodiment of the filter element cleaner in accordance with the present disclosure.

FIG. 7 is an exploded side view of an embodiment of the filter element cleaner in accordance with the present disclosure.

FIG. 8 is a cross-sectional side view of the component of an embodiment of the filter element cleaner, depicted in FIG. 6, in accordance with the present disclosure.

FIG. 9 is an exploded cross-sectional side view of the component of an embodiment of the filter element cleaner, depicted in FIG. 7, in accordance with the present disclosure.

FIG. 10 is a top view of a component of an embodiment of the filter element cleaner in accordance with the present disclosure.

FIG. 11 is a side view of the component of an embodiment of the filter element cleaner, depicted in FIG. 10, in accordance with the present disclosure.

FIG. 12 is a cross-sectional side view of the component of an embodiment of the filter element cleaner, depicted in FIG. 11, in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

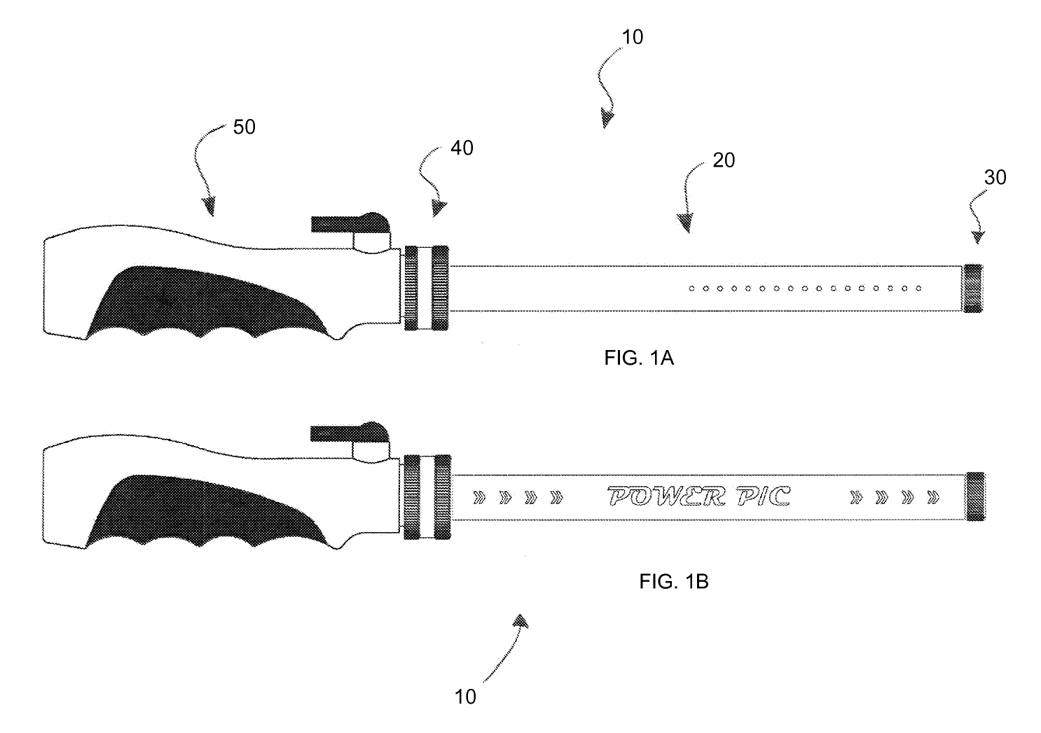

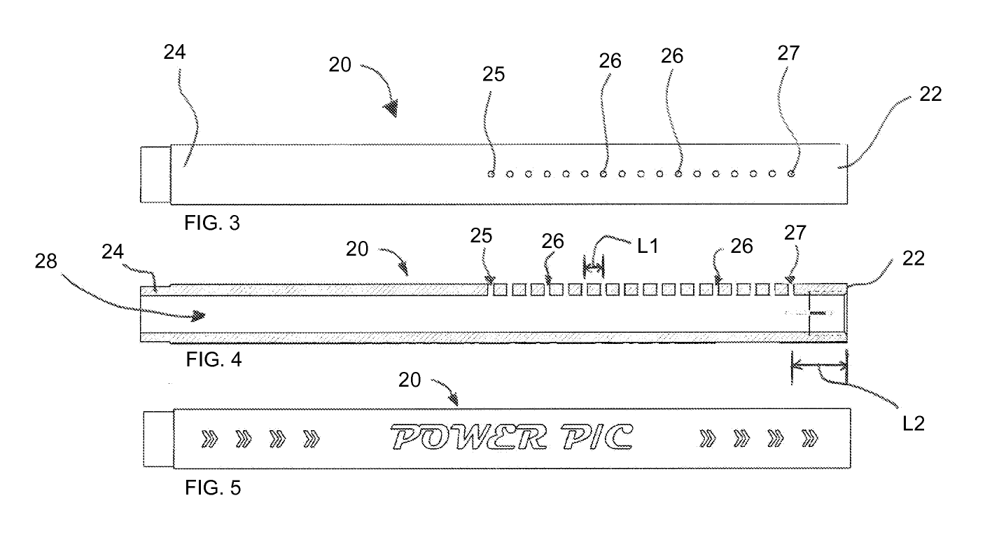

Referring to the drawings, FIGS. 1-5 depict embodiments of a filter element cleaning device 10 according to the present disclosure. The device 10 may comprise one or more components including, for example, and not limited thereto, a body portion 20, an end cap 30, a connector 40, and a handle 50.

Embodiments of the device 10 may comprise a body portion 20. The body portion 20 may be rigid body. The body portion 20 may have a length of material having a first end 22 and a second end 24. The material comprising the body portion 20 should have properties and characteristics so as to be rigid and strong enough to sustain a pressurized fluid source that may run there through. For example, the body portion 20 may be comprised of aluminum, or other hard metal. Further, the body portion may be formed of rigid plastics or other composites of like properties.

The body portion 20 may have identifying information, such as brand name, printed, etched, carved, engraved, stamped, impressed or otherwise placed on the exterior surface of the body portion 20.

Embodiments of the device 10 may further comprise the body portion 20 being cylindrical in shape, such that its cross-section is circular. The body portion 20 may have a hollow interior such that a center bore 28 runs through, as depicted in FIG. 4. The center bore 28 may be configured to receive and direct a pressurized fluid that may be coupled to the body portion 20. The center bore 28 may have a diameter 29. The center bore 28 may run the entire length of the body portion 20, such that the first and second ends 22 and 24 are open. The center bore 28 may have threaded internal ends, such that other components of the device may be releasably coupled to the body portion 20 via the threaded internal ends. The diameter and size of the body portion 20 may be configured to be small enough to fit into tight or otherwise hard-to-reach spaces that other conventional filter cleaners may not be able to reach.

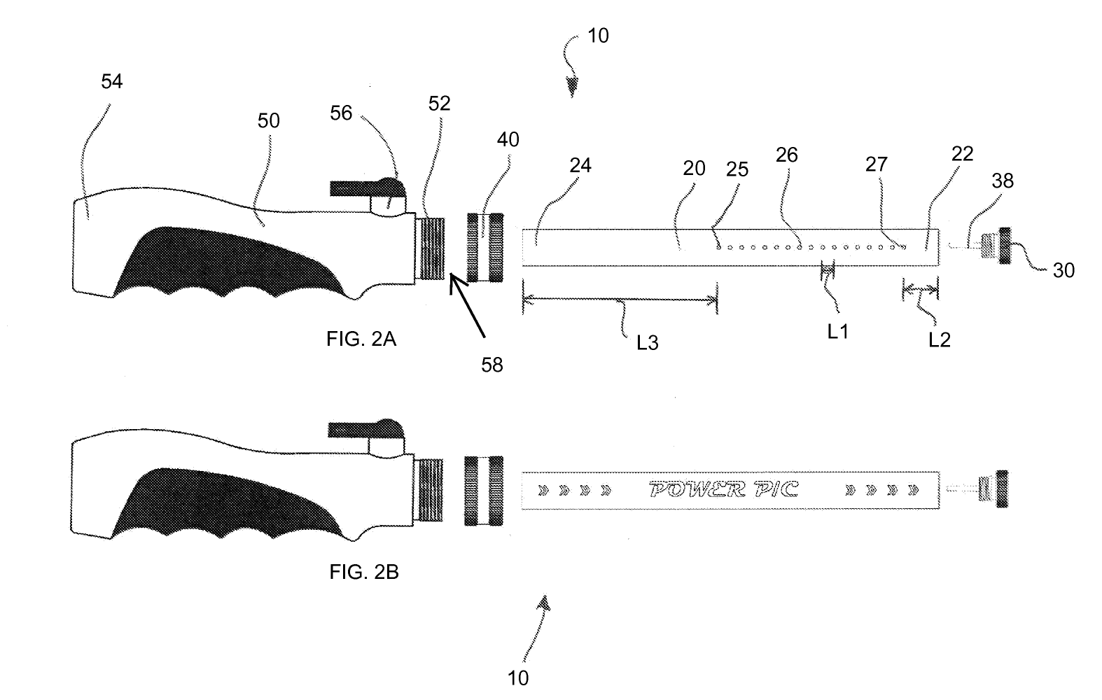

Embodiments of the device 10 may comprise the body portion 20 having an aperture 26 therein. The body portion 20 may further comprise a plurality of apertures 26, as depicted in FIGS. 2A, 3 and 4. The apertures 26 may be spaced apart from one another a first predetermined distance L1. The apertures 26 may be positioned on the body portion 20 so as to form a single-file line running in parallel with the axis of the body portion 20. The apertures 26 may be configured in two or more parallel lines running in parallel with the axis of the body portion 20. The apertures 26 may be configured in a random pattern over half the circumference of the body portion 20. The apertures 26 may be configured in a spiral pattern over the body portion 20, or, alternatively, over half the circumference of the body portion 20. The plurality of apertures 26 may comprise an end aperture 27 that lies closest to the first end 22 of the body portion 20. The end aperture 27 may be spaced a second predetermined distance L2 from the distal edge of the first end 22, the second distance L2 being greater than the first distance L1. The plurality of apertures 26 may comprise an initial aperture 25 that lies closest to the second end 24 of the body portion 20. The initial aperture 25 may be spaced a third predetermined distance L3 from the distal edge of the second end 24, the third distance L3 being greater than the second distance L2.

Embodiments of the device 10 may further comprise the apertures 26 being in fluidic communication with the center bore 28. The apertures 26 may be drilled into the body portion 20. Alternatively, body portion 20 may be punctured to create the series of apertures 26. Alternatively, the apertures 26 may be integrally formed with the body portion 20. The apertures 26 may be configured to be in fluidic communication with the central bore 28 and thus direct the pressurized fluid that is within the central bore 28 out of the central bore 28. In other words, the pressurized fluid may exit the body portion 20 via one or more of the apertures 26. Each of the plurality of apertures 26 may have substantially the same diameter so as to establish a uniform flow of pressurized fluid exiting the body portion 20. Alternatively, the apertures 26 may have varying diameters to create varying degrees of pressurized fluid flow out of the apertures 26. The apertures 26 may be configured in the body portion 20 so as to direct the flow of pressurized fluid out of the apertures 26 at an angle that is substantially orthogonal to the axis of the body portion 20. In this way, the user of the device 10 may anticipate and rely on the angle at which the pressurized fluid will exit the body portion 20.

Embodiments of the device 10 may further comprise the apertures 26 being positioned in the body portion 20 to create a pressurized back flow in the central bore 28 to create a uniform pressure within the central bore 28 to create a uniform flow of fluid from each of the apertures 26. For example, the number of apertures 26 may be configured to provide that the pressurized fluid achieves a certain pressure measurement within the central bore 28. For example, the positioning of apertures 26 along the length of the body portion 20 may be configured to provide that the pressurized fluid achieves a certain pressure measurement within the central bore 28. As depicted in FIG. 2A, the apertures 26 are configured in a straight line along the length of the body portion 20, but the initial aperture 25 is positioned proximate the center of the length of the body portion 20, such that the apertures run from substantially the center of the length of the body portion 20 to proximate the first end 22. Moreover, the end aperture 27 may be spaced apart a distance L2 from the terminal edge of the first end 22 that causes a backflow to result within the central bore 28 and keeps the pressure of the fluid within the central bore 28 at a uniform level along the length of the body portion 20, at least where the pressurized fluid exits the body portion 20 via the apertures 26.

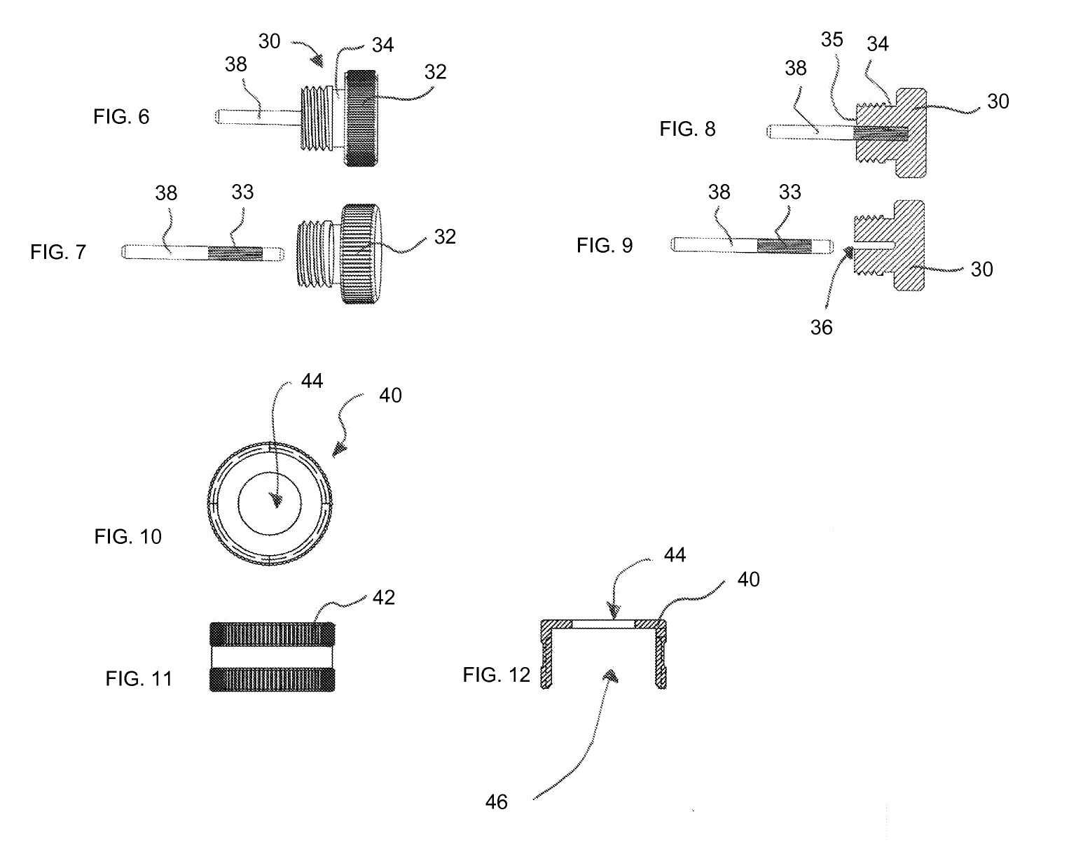

With particular reference to FIGS. 6-9, embodiments of the device 10 may further comprise an end cap 30. The end cap 30 may be configured to be repeatedly and releasably coupled to the first end 22 of the body portion 20. The end cap 30 may be configured to fluidically seal the first end 22 of the body portion 20, such that the pressurized fluid within the central bore 28 does not escape from the central bore 28 via the first end 22. The end cap 30 may have external threads that are configured to cooperate with the internal threads of the body portion 20. However, the end cap 30 may be configured to repeatedly and releasably couple to the first end 22 of the body portion 20 via other connection means, such as snapping in place, friction fit, or other means. The end cap 30 may further comprise a textured surface 32 to facilitate gripping and twisting of the end cap 30, when desired to insert the end cap 30 into the body portion 20 or remove the end cap 30 from the body portion 20, as needed. The end cap 30 may further comprise a projection portion 34. The projection portion 34 may have a diameter that is substantially the same as the diameter of the central bore 28. The projection portion 34 may have configured thereon the external threads mentioned above for coupling with the threads of the body portion 20. The projection portion 34 may be configured with an indention 36 therein to receive and maintain an aperture cleaning tool 38. The projection portion 34 may have a uniform edge face 35. Except for the indention 36, which may, more often than not, house the tool 38 such that the indention 36 is obscured, the face 35 may be flat and substantially uniform so as to not further hinder the flow of water within the central bore 28 and against the face 35.

Embodiments of the device 10 may further comprise the aperture cleaning tool 38. The tool 38 may be a rigid body having a first end 37 and a second end 39. The first and second ends 37 and 39 may be initially tapered, so as to facilitate insertion of the tool 38 within the indention 36 and within the apertures 26. The tool 38 may have a diameter that is substantially the same as, or slightly smaller than, the diameter of the apertures 26. The tool 38 may further comprise a surface feature 33. The surface feature 33 may be a raised portion or a series of ribs along the length of the tool 38. The surface feature 33 may be a series of peaks and valleys alternating around the circumference of the tool 38. The tool 38 may be coupled within the indention 36 in the end cap 30, such that under the condition the end cap 30 is coupled to the body portion 20, the tool 38 is stored within the body portion 20 when the tool 38 is not in use. Embodiments of the device 10 may further comprise the tool 38 being releasably and repeatedly coupled to and removed from the end cap 30, as desired. For example, the tool 38 may be removed from the end cap 30 and inserted in one or more of the apertures 26 to clean the diameter of the apertures 26. With use, the apertures 26 may become clogged with debris or sediment. The tool 38 may therefore be used to push out, drive through, scrape, rub, graze, or otherwise remove debris and unwanted clutter from the aperture 26 to maintain the aperture 26 in optimal performance. Once finished, the tool 38 may be replaced within the indention 36 of the end cap 30 and the end cap 30 can be coupled to the first end 22 of the body portion 20, as discussed above. Alternatively, embodiments of the device 10 may further comprise the tool 38 being fixedly coupled to the end cap 30, such that if the tool 38 is needed to clean the apertures 26, the end cap 30 may be disengaged from the body portion 20, thus removing the tool 38 therewith, and the end cap 30 may be used as a handle of sorts to manipulate the tool 38 into and out of the apertures 26 to clean the apertures 26, as discussed herein. With the tool 38 being fixedly coupled to the end cap 30, the end cap 30 may provide better control, influence, and operation of the tool 38 during communication with the apertures 26, not to mention greater pressure, strength, and force than might otherwise be possible without the end cap 30.

Embodiments of the device 10 may further comprise the surface feature 33 of the tool 38 being utilized to frictionally engage the tool 38 within the end cap 30 so that the tool 38 may not be removed from the end cap 30 without undue force. In this way, should the tool 38 be desired to be used, the user may remove the end cap 30 and utilize the end cap 30 as a handle of sorts to manipulate the tool 28 to clean the apertures 26, as discussed herein, without the tool 38 disengaging from the end cap 30. The tapered initial edges of the first and second ends 37 and 39 of the tool 38 may assist in the insertion of the tool 38 within the apertures 26. Once finished with the cleaning of the apertures 26, the end cap 30 with the tool 38 coupled thereto, can be replaced on the first end 22 of the body portion 20. In embodiments of the device 10, the tool 38 may be positioned and rest securely within the central bore 28, thus being hidden from view and protected against the possibility of being lost.

Embodiments of the device 10 may further comprise a connector 40. The connector 40 may comprise a rigid body for securing the body portion 20 thereto. More specifically, the second end 24 of the body portion 20 may be functionally engaged by the connector 40. The connector 40 may define a cavity 46. The cavity 46 may be configured to receive, releasably couple to, and maintain connected with the source of the pressurized fluid, such as a residential or commercial water line, a compressed body of water, or other pressurized source of fluid. The connector 40 may have a bore 44. The bore 44 may be configured to receive the second end 24 of the body portion 20, such that the body portion 20 may be coupled to the connector 40. The connector 40 may further comprise a textured surface 42 to facilitate gripping and twisting of the connector 40.

Embodiments of the device 10 may further comprise a handle 50. The handle 50 may include a first end 52 and a second end 54, the handle further comprising a central bore 58 there through. The handle 50 may be configured to be placed between the connector 40 and the pressurized fluid source. In other words, the first end 52 of the handle 50 may functionally engage the connector 40 and the second end 54 may functionally engage the pressurized fluid source. In this way, the pressurized fluid may travel through the central bore 58 of the handle 50 and into the central bore 28 of the body portion 20. Once inside the body portion 20, the fluid may be directed out of the central bore 28 via one or more of the apertures 26, as described herein. The handle 50 may further comprise an ergonomic design that facilitates the hand grip of a user. The handle 50 may further comprise a flow switch 56, such as an on/off ball valve, that may be configured to regulate the flow rate and volume of fluid that may enter the central bore 28 of the body portion 20. Embodiments of the device 10 may further comprise the body portion 20 incorporating the flow switch 56. The flow switch 56 provides the benefit that the user may adjust the flow rate of the fluid exiting the apertures 26 and thus manipulate the impact pressure for whatever filtration or non-filtration component that is being cleaned with the help of the device 10.

Embodiments of the device 10 may further comprise the device 10 being configured to connect to a regular garden hose, via the connector 40 or the handle 50, as described herein, thus making the device 10 generally quick and convenient to use. Yet still, with the garden hose connected to the device 10, the device 10 may provide adequate water pressure, including adjustable water pressure via the on/off ball valve, for many different applications. The fact that the device 10 does not need an external powered water pump makes the device 10 and its associated function a very cost effective solution to the problem of cleaning filter elements, such as cartridge filters.

Embodiments of the device 10 may further comprise the body portion 20 having an adjustable length. Moreover, the body portion 20 may be manufactured with different set lengths. In this way, one length may be used for one filter-cleaning operation whereas another length, either shorter or longer, can be used for another filter-cleaning operation. Indeed, the length of the body portion 20 is not limited by the present disclosure. The relatively slender design of the body portion 20 facilitates the cleaning of filter elements from the outside-in as well as from the inside-out. Furthermore, the relatively slender design of the device 10 does not incorporate pleat separating projections that might cause filter damage, nor does the design incorporate an open cavity that might lower water pressure within the body portion 20 and thus diminish the impact pressure of the device 10 on the filter to be cleaned.

The current disclosure, although simple in design, incorporates maintenance requirement feedback from top technicians and engineers in several industries for various applications.

Basic testing was performed by Mikise Filter Tools in Gilbert, Arizona. The first step was to establish what the average water pressure is in a residential home. The national recognized authority in this area is the IRC (International Residential Code) Sections P2903.3 & P2903.3.1, which states that the minimum water pressure for residential dwellings is 40 psi and the maximum water pressure is 80 psi with a national average of 55 psi, as per the IRC. An additional test was performed with a standard garden hose to establish the water volume produced from the device 10, under average water pressure, and the result was 10 gpm (gallons per minute) of water flow.

With the foregoing parameters, the device 10 was tested against available tools in different industries as well as a standard garden hose for effectiveness and performance. The following are the results:

The “Water Wand” U.S. Pat. No. 8,276,605 produced 4½ to 5 gpm and projected a water stream of 10-12 feet when held parallel to the ground. In comparison, the device 10 produced 8½ to 9 gpm and projected a water stream of 28-30 feet when held parallel to the ground. The significance of the water stream test establishes a reasonable conclusion regarding the impact pressure from the body portion 20 (and apertures 26) to the pleats of the cartridge filter. The basic test shows that the device 10 created superior results for the cleaning of cartridge filters in both gallons per minute and impact pressure testing.

Additional independent testing was performed by Abhilash Pillai—Director of Research at Pleatco in Glen Cove, N.Y. which is known to the pool & spa industry as the world's largest manufacturer of cartridge filters. The additional testing was performed under the NSF International Organization's NSF-50 guidelines on clean ability of cartridges. Refer to annexure B.4.3.1, which states “Tap water with 4.8±1 g (0.04±0.01 lb.) of ball clay21, 189 mg baby oil22, and 4.8±1 g (0.04±0.01 lb.) of diatomaceous earth (for non-DE filters) added for every gallon per minute of flow rate at which the filter is tested”.

Pleatco's statements and results are listed as follows:

We (Pleatco) loaded the Pleatco cartridges heavily to 30-33 psi at this point the cartridges were “depth loaded” and “completely caked” making it more challenging to clean them. We were able to clean them (with the device 10) down by 20 psi reaching a 10-13 psi rating. We also tested under real world scenario's which included cartridge filters with heavy algae deposits & debris and were able to achieve the same results as the NSF-50 testing specifications.

Regarding the micron rating of the filter media - the micron rating of the filter depends on the fiber lay down pattern by the manufacturer. It can be chemically altered or damaged by improper cleaning. The device 10 was tested against the three leading manufacturers of filter media and found that the device 10 did a thorough job and did so without damaging the media or degrading the micron rating. We (Pleatco) endorse the Power Pic as safe to use on all filtration media in the pool & spa industry.

We (Pleatco) tested the device 10 against a normal garden hose and a single spray nozzle. The garden hose consumed too much water and time to clean the cartridge and the single spray nozzle was too powerful wasting lot of water was difficult to focus in between the pleats and was displacing the media thus diminishing the micron rating and the filters efficacy to filter out debris & particles.

The device 10 with the evenly distributed water jets and broad nozzle design allowed us (Pleatco) to clean multiple pleats and depths simultaneously. I was really impressed by the water conservation aspect and the overall feel of the tool. We (Pleatco) would say that the device 10 is an eco-sustainable green product.

Lastly, the fact that the device 10 is made from 100% aluminum we feel, sets it apart from all other tools on the market today. Most, if not all, other tools primarily made specifically for cleaning cartridge filters are made from plastic mold injection and would not have the longevity across multiple geological scenarios and weather conditions as the device 10 presents.

In all these respects the present disclosure substantially and clearly departs from conventional concepts and thus provides an improved cleaning device 10 with none of the drawbacks of previous art and all of the improved upgraded design benefits.

The components defining the above-described cleaning device 10 may be formed of any of many different types of materials or combinations thereof that can readily be formed into shaped objects provided that the components selected are consistent with the intended operation of a filter element cleaning device of the type disclosed herein. For example, and not limited thereto, the various components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described cleaning device 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A filter element cleaning device, the device comprising:
a body portion having a central bore and opposing distal ends;
an end cap configured to be releasably coupled to a first opposing distal end;
a connector configured to functionally engage a second opposing distal end;
a plurality of apertures configured on the body portion between the opposing distal ends, the plurality of apertures being spaced apart a first distance from one another, the apertures being in fluidic communication with the central bore; and
an end aperture of the plurality of apertures, wherein the end aperture is spaced away from the first opposing distal end a second distance greater than the first distance.

2. The device of claim 1, wherein the central bore of the body portion is configured to receive a pressurized fluid from a pressurized fluid source and direct the pressurized fluid out of the plurality of apertures.

3. The device of claim 2, wherein the second distance creates a fluidic back pressure in the body portion resulting in a substantially even dispersion of the pressurized fluid from each of the plurality of apertures.

4. The device of claim 2, wherein the plurality of apertures direct the pressurized fluid source out of the body portion in a direction substantially orthogonal to an axis of the body portion.

5. The device of claim 1, wherein the end cap fluidically seals the first opposing distal end.

6. The device of claim 1, wherein the plurality of apertures are aligned in parallel with an axis of the body portion.

7. The device of claim 1, wherein the plurality of apertures are drilled into the body portion.

8. The device of claim 1, wherein the body portion is cylindrical.

9. The device of claim 1, wherein the connector is configured to receive and retain thereon a pressurized fluid source.

10. The device of claim 9, wherein the pressurized fluid source is a residential water line.

11. The device of claim 1, further comprising a handle, wherein the handle is configured to be inserted between the connector and a pressurized fluid source.

12. The device of claim 11, wherein the handle has a central bore and opposing ends, the handle being configured to releasably couple to the connector on a first opposing end and to releasably couple to a pressurized fluid source on a second opposing end.

13. The device of claim 11, wherein the handle is configured to restrict a flow of the pressurized fluid source to increase or decrease the pressure of the fluid within the central bore of the body portion.

14. The device of claim 1, further comprising a first aperture of the plurality of apertures, the first aperture being positioned a third distance from the second opposing distal end, the third distance being greater than the second distance.

15. The device of claim 1, the central bore having a diameter, the diameter being substantially the same as the second distance.

16. The device of claim 1, wherein the body portion can be manufactured to varying lengths.

17. A filter element cleaning device, the device comprising:
a body portion having a central bore and opposing distal ends;
an end cap configured to be releasably coupled to a first opposing distal end;
a connector configured to functionally engage a second opposing distal end;
a plurality of apertures configured on the body portion between the opposing distal ends, the plurality of apertures being spaced apart a first distance from one another, the apertures being in fluidic communication with the central bore;
an end aperture of the plurality of apertures, wherein the end aperture is spaced away from the first opposing distal end a second distance greater than the first distance; and
an aperture cleaning tool, the aperture cleaning tool being configured to be coupled to the end cap, such that the aperture cleaning tool is housed within the central bore of the body portion under the condition the end cap is coupled to the first opposing distal end.

18. The device of claim 17, wherein the aperture cleaning tool is cylindrical and has a diameter substantially the same as the diameter of each of the plurality of apertures, such that under the condition the end cap is detached from the body portion the aperture cleaning tool may be inserted within each of the apertures and slidably engage the apertures.

19. The device of claim 17, wherein the aperture cleaning tool has a surface feature.

20. The device of claim 19, wherein the surface feature is a ribbed section, wherein the ribs run parallel with an axis of the cleaning tool.
